(19) United States
(12) Patent Application Publication
(10) Pub. No.: US 2006/0014017 A1
(43) Pub. Date: Jan. 19, 2006

(54) Diffractive pigments

(75) Inventors: Steffen Pilotek, Wil (CH); Rene Zimmermann, Zuberwangen (CH); Martin Mennig, Quierschied (DE); Helmet Schmidt, Saarbucken-Gudingen (DE); Peter-William Olliveira, Saarbucken (DE)

Correspondence Address: SUTHERLAND ASBILL & BRENNAN LLP, 999 PEACHTREE STREET, N.E., ATLANTA, GA, 30309, US

(73) Assignee: Buhler AG, Uzwill (CH)

(21) Appl. No.: 10/533,698

(22) PCT Filed: Sep. 16, 2003
(86) PCT No.: PCT/CH03/00624

§ 371 Date: May 3, 2005

(30) Foreign Application Priority Data
Nov. 11, 2002 (DE) 102 52 645.1

(51) Int. Cl. D01D 5/40; B29C 35/04; B32B 15/02

(52) U.S. Cl. 428/402; 264/401; 264/140

(57) ABSTRACT

The invention relates to a pigment, the smallest size of which corresponds at least to a multiple of the greatest wavelength of ultraviolet light or the smallest wavelength of visible light. Said pigment comprises at least one defined diffractive structure, the spatial periodicity, of which has a spatial period corresponding at least to a multiple of the wavelength of ultraviolet light. In particular, the inventive pigment has a laminar shape. The method for producing such pigments comprises the following steps: a) a defined diffractive structure is created in and/or on a film-type support: b) the defined diffractive structure is coated with a sealant on said support: c) the film-type support processed in steps a) and b) is comminuted so as to form pigment particles.

The invention concerns a diffractive, specifically holographic, pigment resp. pigment powder containing such pigment particles, as well as a procedure for its production.

Pigments as coloring and/or color-producing elements are known in numerous versions. In conventional color production using pigments, one on the one hand uses a) the selective absorption of designated frequencies and/or wave lengths in the pigment material by selective excitation of electron transfers in atoms and/or molecules of the pigment material or by selective excitation of electron vibrations within characteristic functional groups of pigment materials. On the other hand, one employs b) using a regular structuring of generated runtime distinctions in the pigment materials to achieve diffraction or interference effects.

Paints and lacquers frequently contain dyes or pigments that project color impressions by absorption such as in a). Extensive state-of-the-art technology exists for manufacturing diverse pigments and dyes by chemical synthesis. Their advantage is their manipulability, such that the color-yielding component can be added to the desired system of bonding agents. Extensive state-of-the-art technology for treating pigments in manufacturing printing colors or other color-producing formulations is known as well.

For producing color and/or preparing color structures per b), one employs interference pigments, holograms as well as otherwise diffractive and/or refractive pigments.

Interference pigments are optical multi-layer structures on which the color impression will be generated by repeated transmission and reflection on the interfaces of the different layers via constructive and destructive interference. For this purpose, carrier materials are laminated with a sequence of optically high and low refracting materials in complex procedures in which controlling layer thickness is of major importance. Then, the multi-layer structures are reduced to “pigment-platelets”, whereby separation from the substrate can occur before or after the reduction. Examples of this are U.S. Pat. No. 4,434,010 or EP 0 227 423.

Holograms (cf. “Holographie-Fibel”; Peter Heiss; ISBN 3-88984-029-9) are optical structures which, similar to interference pigments, but in contrast to pigments as per a), are independent of the chemical nature of the actual pigment substances. According to viewing angle und illumination, they occasionally show a color imprint and, with proper illumination, can reproduce the three-dimensional object waves that radiate from the “holographically stored” object, so that a three-dimensional impression emerges.

Defined colors also may be realized by using diffractive elements, such as, for example, a diffraction grating acting as a color filter. Such, for example, are the line patterns known from U.S. Pat. No. 3,957,354 or EP 0 632 296, which, upon exposure to sunlight or another polychromatic light source, lead to specifically defined impressions.

Another approach uses DE 199 12 160. To produce a color picture or hologram that is present as a digitally stored image, points with a maximum diameter of 1000 μm are embossed on a material with a durably embossable surface, that in each case exhibits a pattern of lines running parallel, which, depending on the color to be produced, are at intervals in the range of 100 nm to 2000 nm. Embossing the points is done with a dot-matrix printer that presents one set of needle points for the requisite primary colors.

The underlying task of the invention is facilitation of high-quality printing by means of existing pigment-based printing methods, whereby, in particular, the aforementioned needle printing procedure in the passage above would, for example, be replaced by a familiar ink-jet printing method based on pigments.

This task is resolved by a pigment as per claim 1 resp. a print color as per claim 38, which will be produced using a procedure as per claim 24.

For the as per invention-pigment, the smallest pigment dimension is a multiple of the largest wave length (ca. 400 nm) from ultraviolet light, whereby the pigment at least displays a defined diffractive structure whose smallest spatial periodicity has a spatial period that is at least a multiple of the largest wave length (ca. 400 nm) of ultraviolet light.

In this way, there is enough space available on the pigment to accommodate several parallel diffraction lines in a diffraction grating on the pigment surface. Most of all, it is possible to accommodate gapped parallel diffraction lines along the smallest dimension of the pigment.

The smallest pigment dimension is notably at least a multiple of the largest wave length (ca. 800 nm) of visible light, and the pigment at least exhibits a defined diffractive structure, the spatial periodicity of which has a spatial period that is at least a multiple of the largest wave length (ca. 800 nm) of visible light.

In this way, the pigment generates a diffraction pattern in the UV range as well as in the visible range, such that the UV diffraction pattern is, for example, used for safety-related applications, while the visible diffraction pattern serves purely decorative purposes.

The as per invention-pigment preferably has a platelet-like shape, whereby at least one side of the platelet displays a diffractive structure (a diffraction grating). Upon printing, it is thereby guaranteed that, when printing a substrate surface, the pigment will always lie flat on the substrate surface, whereby all pigments are at a uniform level and bring forth a defined, possibly angle-dependent, color effect, at least over surfaces that are not too large. If the diffraction grating is developed on both sides of the platelet, it is of no consequence which side of the platelet is up or down.

Preferably, the pigment has a periodic diffractive structure with a defined spatial frequency and spatial alignment encompassing the entire pigment. In this way, a definite, spectrally pure color impression can be achieved. So, for example, an entire batch of primary colors for additive (subtractive) color mixing can be prepared. As these diffractive pigments can be arbitrarily aligned upon printing within the plane defined by a level substrate surface, it will nevertheless be ensured that sufficiently much of the pigments will be viewed from the “proper direction”, that is, for example, vertical to the direction of the parallel diffraction lines. In the statistical mean, therefore, about half the “color potential” will always be used, a potential which could fully be reached only if it were it possible to identically align all pigments with one type of parallel diffraction lines within the defined plane, which one would look at vertically to the direction of the diffractive lines.

Alternatively, the pigment can exhibit distinctive areas with, in each case, a divergent periodic diffractive structure. So, for example, on one and the same pigment, both diffraction lines that are parallel to one another in a primary direction and diffraction lines that are parallel to one another in a secondary direction can be present, whereby both directions preferably run vertical to one another. This ensures that each of the arbitrarily aligned pigments will always be viewed from the right direction, that is, for example, always with a component vertical to the alignment of parallel diffraction lines. Here, too, about half the “color potential”, as a statistical mean, will always be used, which could fully be reached only if it were it possible to identically align all pigments with only one type of parallel diffraction lines (see preceding section) within the defined plane, and then look at them vertically to the direction of the diffraction lines.

Appropriately, the individual pigments present rotationally symmetrical or polygon-shaped diffraction gratings that consist of concentric circular-shaped resp. polygon-shaped diffraction lines. This also achieves a color impression that is practically independent of direction, as explained in the previous section.

The separate areas with, in each case, a different periodic diffractive structure can be distinguished in the spatial frequency and/or spatial alignment of the periodic structure of the area in question. This facilitates pigments with overlaid color effects in the visible area, but also with a diffractive effect in the adjacent ultra-violet or infrared area. Specifically, the pigment exhibits a diffractive structure in ultraviolet light and a diffractive structure in natural light. Such a pigment appears colored in the visible area and, on the other hand, upon irradiation with a suitable UV-source and visualization of its “UV-color” (e.g. at a UV-florescent screen), can be examined as to its authenticity. It therefore lends itself particularly well to authenticating documents, in that these are printed with this sort of pigment.

The as per invention-pigment appropriately possesses a periodic diffractive structure extending over the entire pigment, this structure being an overlay of differently identified spatial frequencies and spatial alignments. From this result, among others, pigments with an angle-dependent color effect, whose color impression for the observer depends on the angle between the observer's viewing direction and the pigment level (pigment platelets),

The as per invention-pigment can also be a clip from a hologram.

According to a particularly advantageous implementation, the as per invention-pigment consists of an optically permeable material, whereby the defined diffractive structure is bestowed by a defined spatial allocation of the pigment thicknesses d(x,y) and/or refraction index n(x,y) of the pigment material. The diffractive structure is then bestowed by the thus modulated optical path length s(x,y)=n(x,y)−d(x,y). Such transmission pigments are “colored” in both exposure directions.

According to a further advantageous implementation, the pigment contains an optically permeable material, in the interior of which a reflective layer is arranged. Even such reflective pigments are “colored” on both sides. Appropriately, the defined diffractive structure is a defined spatial allocation of rises and recesses Δh(x,y) of a reflective surface layer of the pigment, which is preferably surrounded by an optically permeable sealant with refraction index n(x,y), so that, here too, the diffractive structure is represented via the thereby modulated optical path length s(x,y)=2n(x,y)·Δh(x,y).

The dimensions of the as per invention-pigment are in the range between 5 μm and 200 μm and specifically in the range between 10 μm and 30 μm, whereby notably its length and breadth lie in the range between 5 μm and 200 μm and more particularly in the range between 10 μm and 30 μm. This facilitates the accommodation of a sufficiently large number of periodically prescribed diffraction lines on the pigment for an appreciable color intensity and the necessary contrast between maxima and minima of the diffraction spectrum. Upon irradiation with monochromatic lasers (e.g. laser diodes), the use of very large diffractive pigments would certainly be advantageous, since this light exhibits a very high coherence and would thus induce very intensive light phenomena. In practice, however, it is also very important that operation with conventional light sources, such as, for example, the sun or ordinary lamps (e.g. light diodes), whose light exhibits only a slight coherence length, is possible. In order to ensure coherent wave fronts of the incidental light upon irradiation with less coherent light over the full pigment surface, the pigments should not, as it were, exceed a certain minimal surface.

The thickness of the as per invention-pigment can lie in the range between 0.1 μm and 10 μm and more particularly in the range between 0.5 μm and 5 μm. That suffices for development of ca. 100 nm to 200 nm deep levels in the diffractive structure.

It can also be constructed from at least two layers lying on top of each other, in order to additionally use multilayer interference effects as well. Preferably, it has a defined diffractive surface structure on both surfaces of the platelet and is thereby similar to pigments described above and likewise “colored” on both sides.

Appropriately, the sealant consists of a hydrophobic or hydrophilic material. It is used as a phase mediator for dispersion of the pigments as per invention in a hydrophobic resp. hydrophilic bonding agent.

For special use, it is advantageous if the sealant of the as per invention pigment platelet on one surface consists of a hydrophobic material, and a hydrophilic material on the other surface. In multi-phase liquids, such pigment platelets are accumulated on the phase boundary or boundaries, whereby, in phase equilibrium, the hydrophilic platelet-surfaces are oriented towards the more hydrophilic phase and the hydrophobic platelet-surfaces are oriented towards the more hydrophobic phase.

The as per invention-procedure for production of pigments of the kind described further above involves the following steps:
a) Production of a defined diffractive structure in or on a foil-like medium;
b) Coating the defined diffractive structure on the medium with a sealant substance;
c) reduction of the foil-like medium processed in steps a) and b) to pigment particles.

Step a) can thereby be carried out by embossing, particularly hot stamping, Thixo stamping (according to DE 100 01 135 A1 of the Institute for New Materials INM, Saarbrucken) or reaction embossing, by lithography, particularly electron beam or optical lithography, or by scratching the surface of the medium.

In Step b), the diffractive structure can be covered with a reflective layer. Step b) can be carried out through epitaxy, particularly vapor or fluid deposition•Epitaxy, or through vapor-coating, particularly with metallic vapors.

In Step c), a reduction (snipping and pulverizing) of the foil-like medium can take place in order to obtain the target pigment platelets.

Alternatively, the structured multi-layered construction can first be removed from the medium and then reduced.

Specifically, then, if the foil-like medium employed in Step a) exhibits a relatively elastic, pliable base layer as its initial layer, on which a relatively brittle second layer is introduced in and/or on it, the defined diffractive layer will be produced, then in Step c) folding of the foil-like medium occurs in order to obtain the target pigment platelet as per invention. To facilitate and to locally control the breaking of the relatively brittle second layer (carrier layer), additional predetermined breaking points can be embossed while embossing the defined diffractive structure, which restrict, for example, a rotationally symmetrical or polygon-shaped refraction grating.

If the sealant material used in Step b) is a brittle, especially a lacquer-like or resin-like material, then Step c) can occur by classic pulverization; wet pulverization in an aqueous medium, e.g. with a centrifugal ball mill, is particularly advantageous. Preferably, grinding balls (e.g. plastic “grinding pearls”), whose hardness is less than the hardness of the pigment's sealant agent, are to be used in the process. Thereby, scratching the pigment during the milling process will be prevented.

An as per invention-pigment powder exhibits the pigments produced by the as per invention-procedure described above. They can be coated with an auxiliary agent, specifically a wetting agent.

An as per invention-print color contains the as per invention-pigment powder as dispersion in a bonding agent.

A as per invention-lacquer contains the dispersed as per invention-pigment powder.

An as per invention-transparent plastic, specifically PET, PEN, PBT, PA, PC, contains the as per invention-pigment powder.

For its authentication, a document as per invention exhibits at least one of the following features:
a printed imprint of the as per invention-printing color resp. ink;
a label made of the as per invention-transparent plastic.

The present invention thus provides diffractive resp. holographic pigments as new kinds of color-supplying substances, as well as their production and formulation. The use of such diffractive resp. holographic structures inside a pigment for producing a color impression is interesting on account of the novel optical impression that facilitates optically sophisticated prints. Moreover, pigments as per invention are suited for safety-related applications. On the basis of their production processes and optical properties, such pigments are immediately predestined for security applications.

A particularly advantageous as per invention-procedure for security-related applications employs the following steps:
The production of a particular (authenticating) holographic structure on a carrier medium (e.g. a transparent material, specifically resin, etc.);
vapor-coated with reflective material (e.g. aluminum);
recoating the structure (e.g. with the transparent material mentioned above);
separation of the structure achieved in this way from the medium; and
reducing the separated structure and using the structure particles as pigments.

The holographic pigments thus achieved each contain a reflective layer, e.g. of aluminum, which has stored the holographic structure and which is coated (“sealed”) on both sides with the transparent material mentioned above. These pigments can be employed in diverse bonding agent systems and be used as print color, ink or lacquer.

In accordance with the invention, pure “UV-pigments” as well as mixed UV and visible light pigments (combo-pigments) are possible that can be viewed with standard UV-sensitive facilitators for visualization with UV-light.

The requirement accorded by the invention of “at least a multiple” of the wave lengths of visible light (ca. 400 nm to 800 nm in the air) for minimal pigment measurement (except for pigment thickness) means “at least double”, which corresponds to a “double fissure” to obtain any visible interference color effects or UV-interferences not visible to the naked eye. Of course, several (e.g. 3 to 20) are preferred, which in any case however correlates with the minimal pigment size. As already mentioned above, it is not necessary to have very large pigments, since, upon illumination with “incoherent light” resp. “less coherent light” with short wave trains, such as sun light, light bulb, glow-discharge lamp, light-emitting diode, etc., over the entire major surface as such of a respective pigment, anyway no completely coherent “illumination” occurs, unless the wave fronts have the same or a very similar shape as the diffractive pigment surfaces and are arranged tangentially to these if they impinge on the diffractive pigment surfaces. This is, however, unlikely.

Therefore, in other words, it is particularly advantageous if the holographic structure is reduced to a few micrometers, which is tantamount to having only a few diffraction lines present on each as per invention-pigment for a respective given wave length.

Further advantages, features and application possibilities of the invention accrue from the following description of a preferred effectuation of the pigments as per invention and the as per invention-procedure, whereby

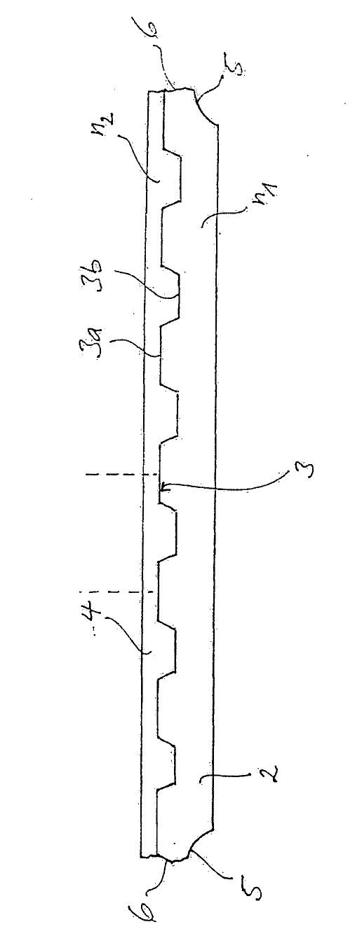

FIG. 1 is a schematic sectional view of a pigment as per invention; and

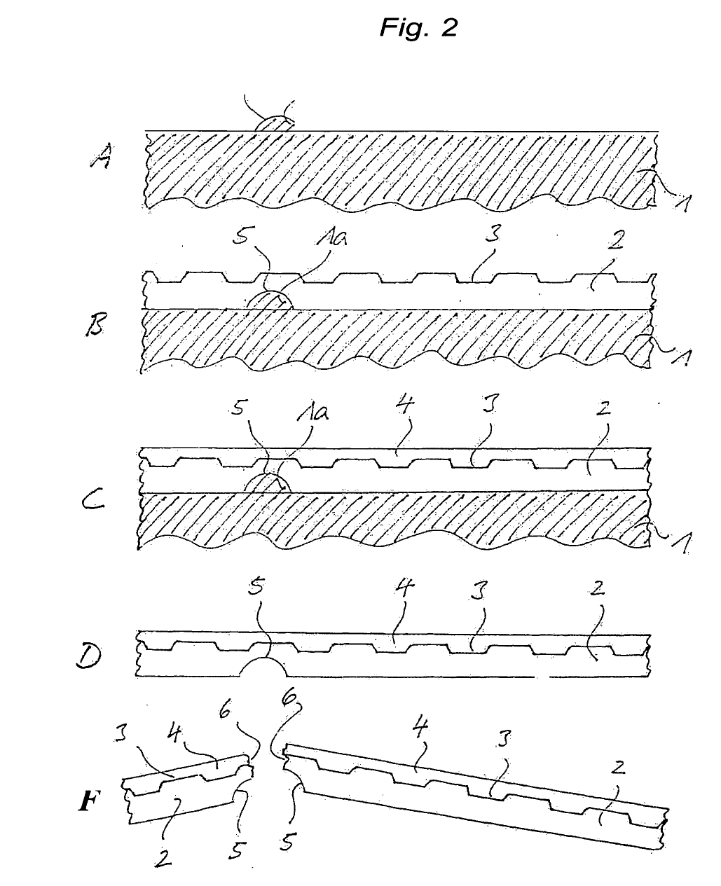

FIG. 2A through 2E are sectional views of the as per invention-pigment, which show step-by-step production of the pigment of FIG. 1 using an as per invention-procedure;

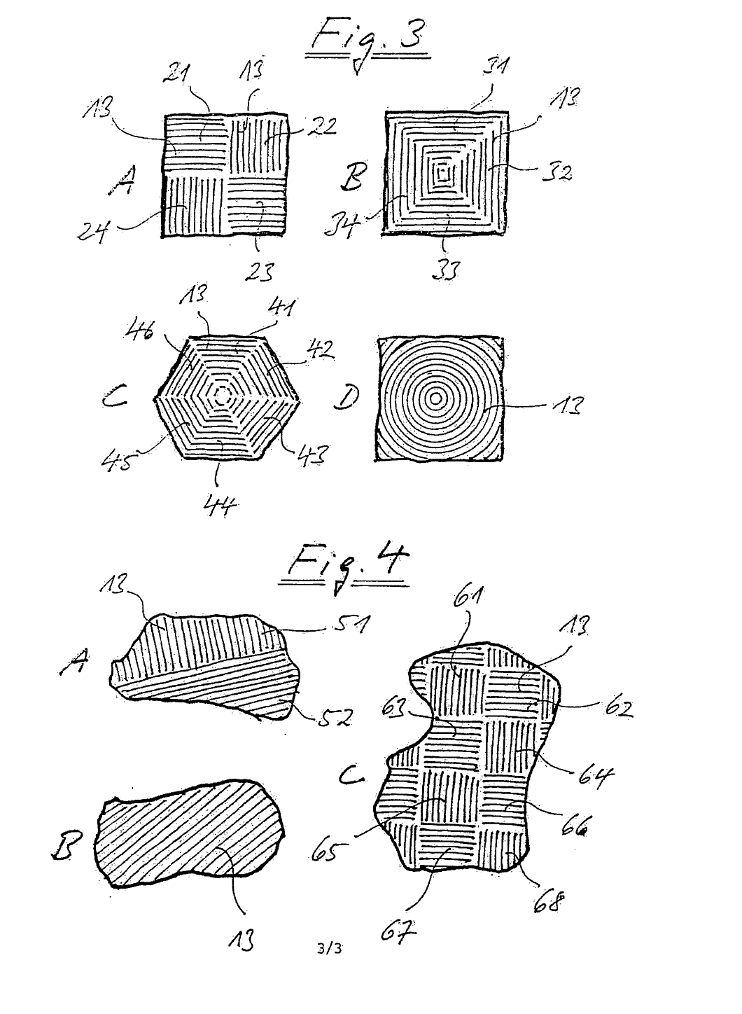

FIG. 3A through 3D are top views of the as per invention-pigment, which show differently defined diffraction line geometries and differently defined pigment shapes; and

FIG. 4A through 4C are top views of the as per invention-pigment that show differently defined diffraction line geometries and different undefined pigment shapes.

FIG. 1 is a schematic sectional view through a platelet-shaped as per invention-pigment vertically to the plane of the platelet. The pigment platelet has a size whose greatest diagonal dimension amounts to about 10 to 30 μm. The pigment platelet consists of a transparent carrier layer 2 with a refraction index n₁ and a transparent sealant layer 4 with a refraction index n₂. The boundary layer 3 between the material of the carrier layer 2 and the material of the sealant layer 4 is developed as a diffractive structure (refraction grating), which exhibits periodically alternating rises 3a and recesses 3b. The diffractive structure of the pigment platelet of FIG. 1 is a sequence of pairs arranged parallel to one another of rises 3a and recesses 3b arranged vertically to the indicator level. The left and right end of the pigment platelet in the drawing is formed by a predetermined breaking point 6, whose position is determined in each case by an available predetermined breaking point 5 in the shape of an indentation 5.

The lattice parameter D of the diffractive structure 3 here, for example, amounts to 2 μm, while the dimension defined by the two predetermined breaking points 5 and vertical to the diffraction lines 3a, 3b, here amounts to 13 μm.

If the pigment platelet of FIG. 1 is irradiated with electromagnetic irradiation 10 in the near-infrared range (ca. 1 μm), in the visible range (ca. 400 nm to 800 nm) or in the near-ultraviolet range (smaller than 400 nm), then in both the reflected electro-magnetic irradiation 11 and in the transmitted electromagnetic irradiation 12, diffraction patterns with constructive interference appear in selected spatial directions for selected frequencies and/or wave lengths of the incidental electromagnetic irradiation 10. The observer can perceive this, at least for optical frequencies and/or wave lengths, as an independent color imprint dependent from the angle of vision (the angle between the viewing direction and the pigment plane) of the pigment. For irradiation in the UV-range and in the IR-range, adequate sensors (e.g. a UV-camera resp. IR-camera) or visual aids (UV-glasses, IR-glasses) must be used to have the different “colors” in the UV and IR ranges made visible. Consequently, the pigment platelets as per invention can be used both for coloring in the visible area of the optical spectrum for decorative purposes as well as for security applications (authentication) that are not visible to the observer's naked eye, but by adequate UV or IR sources and adequate detectors, cameras, etc. which can be called upon for checking the authenticity of an object furnished with the pigment as per discovery.

On the boundary layer 3, on the basis of the difference in the refraction indices n, and n₂ of the carrier layer 2 resp. sealant layer 4, a part of the incidental electromagnetic radiation 10 will be reflected as a first part 11 and transmitted as a second part 12. The reflectivity resp. transmissivity of the boundary layer 3 can be adjusted by the value of refraction indices 1 and n₂. Furthermore, the reflectivity and transmissivity can be adjusted by a metallic layer in the boundary layer 3 between the carrier layer 2 and the sealant layer 4. A very thin metallic layer in the range of the boundary layer 3 is semi-permeable to electromagnetic irradiation, so that the pigment platelet as per invention operates as both reflecting and transmitting. This has the advantage that the pigment platelet can be used both as a print pigment on the surface and as a color-conferring pigment in the interior of transparent bodies. A sufficiently thick metallic layer in the boundary layer 3 (several atomic layers) effectuates, on the contrary, that the invention-accorded pigment platelet merely act reflectively, whereby, however, a higher intensity of the diffraction pattern in the reflecting electromagnetic wave arises.

The depth of the groove-like recesses 3b amounts to ca. 100 nm to 300 nm, it can, however, also exceed these values.

FIGS. 2A, 2B, 2C and 2D show cross-sections of a section of foil essentially corresponding to that in the pigment platelet of FIG. 1, whereby the sequence of sectional views schematically shows the step-by-step production of the pigment platelet of FIG. 1 using an as per invention-procedure.

FIG. 2A shows the initial situation, whereby one begins with a two-ply foil 1, 2, on which a relatively thick base layer 1 (the thickness of which is only partially represented) is coated with a thin carrier layer 2 with refraction index n₁. The base layer 1 exhibits bulge-like rises 1a on its surface at specific intervals, so that the carrier layer 2 laid on the base layer 1 on the sites of the bulge-like rises 1a is thinner, whereby a predetermined breaking point 5 is formed on the carrier layer 2.

FIG. 2B shows the next step in which a defined diffractive structure 3 is embossed on the carrier layer. Apart from the fact that the carrier layer 2 should be transparent, one is relatively free to select a material for the carrier layer 2. Hence, the diffractive structure resp. refraction grating 3 can be produced according to requirements, e.g. by hot stamping, Thixo stamping or reaction embossing.

FIG. 2C shows the next step of the as per invention-procedure in which the defined diffractive structure 3 of the carrier layer 2 produced in the preceding step is coated with a sealant layer 4. Apart from the fact that even the sealant layer 4 should be transparent, here as well, one is relatively free to select materials. The optical reflection properties and transmission properties of the boundary surface layer 3 of the diffractive structure are affected on the one hand by the selection of the refraction indices n₁ and n₂ of the carrier layer 2 resp. of the sealant layer 4 and, on the other hand, by the allocation of a more or less thick metallic layer (not shown) in Step B.

FIG. 2D shows a further step in which the basic layer 1 was detached and/or completely eliminated from the carrier layer 2. The breakup and/or elimination of the carrier layer 2 can be induced by a suitable solvent and/or by mechanically stressing the interface between the basic layer 1 and the carrier layer 2. In place of the bulge-like rises 1a of the basic layer 1 that has now been removed, there is now a predetermined breaking point 5 in the shape of an indentation. The pigment foil produced in this way now has the optical properties of the target pigments. The carrier layer 2 is crossed with predetermined breaking points 5 on which breaking is to be expected upon mechanical stressing of the pigment foil.

FIG. 2E shows a further step toward reduction of the pigment foil of FIG. 2D, whereby pigment platelets are achieved. By so doing, the respective breaks 6 of the pigment platelets that are produced emerge in the area of the predetermined breaking points 5. Coarse reduction of the pigment foil per FIG. 2D can, for example, take place by bending, whereby the large fragments thus achieved can be filled into a conventional reduction apparatus. To reduce pigment platelets, one can resort to either a wet or a dry grinding procedure. Suitable for this are mills, e.g. percussion or impact mills (dry grinding procedure) or centrifugal ball mills (wet grinding procedure). As grinding balls (grinding pearls) in a ball mill, grinding balls with a hardness equal to or slightly less than the hardness of the carrier layer 2 or the sealant layer 4 are used. This ensures that the surface of the carrier layer 2 and the sealant layer 4 will not be scratched, so that color intensity of the pigment platelets is not impaired.

FIGS. 3A, 3B, 3C, 3D are schematic top views of pigment platelets as per invention. Although each one has a different shape, which is determined by the arrangement of the predetermined breaking points 5 in the carrier layer 2 (see FIG. 1 and FIG. 2), all four of the examples shown here have in common that they show different areas with diffraction lines aligned in different manners. So the quadratic pigment platelets of FIG. 3A and FIG. 3B each have four areas 21, 22, 23, 24 and/or 31, 32, 33, 34, whose diffraction lines 13 in each case are aligned such that the alignments of the diffraction lines 13 of adjacent areas are in each case vertical to each other. The pigment platelet of FIG. 3C has the shape of a hexagon that shows six areas 41, 42, 43, 44, 45, 46 in which the diffraction lines 13 in each case are so aligned as to enclose a bend of 120 degrees with the diffraction lines 13 of an adjacent area. The pigment platelet of FIG. 3D has, like the pigment platelets of FIG. 3A and FIG. 3B a quadratic shape, but has a circular symmetrical pattern of circular diffraction lines 13 arranged concentrically to each other.

The arrangement of diffraction lines aligned to each other with, in each case, different alignments in different sectors of the pigment platelet makes the color imprint that originates through interference of the diffracted light in the diffraction spectrum independent of the respective arrangement within the surface of an object coated with the pigment platelets.

As the predetermined breaking points 5 represented in FIG. 1 and FIG. 2 do not normally correlate with the diffractive structure 3, since their embossing on the base layer 1 takes place independently of embossing the diffractive structure 3 on the carrier layer 2, this is taken care of by the pigment platelets of FIGS. 3A, 3B, 3C and 3D that there is such a correlation. This can be accomplished such that the predetermined breaking points 5 will be produced in concert with the diffractive structure by using an impact device that exhibits both the diffractive structure and the bulge-like rises as complementary elements for the predetermined breaking points 5.

FIGS. 4A, 4B, 4C are top views of schematic pigment platelets that have an un-defined pigment shape. They emerge, for example, by further beforehand reduction along the predetermined breaking points of an already reduced pigment platelet (cf. FIG. 3) e.g. by using a grinding procedure). According to the size of the pigment platelets and the size of the area with differently aligned diffraction lines 13 one obtains pigment platelets with more or less much different areas with a prevailing alignment of diffraction lines 13. Thus, for example, the pigment platelet of FIG. 4A has both areas 51 and 52 with the refraction lines 13 vertically aligned to each other, the pigment platelet of FIG. 4B has only a single alignment of the diffraction lines 13 and the pigment platelet of FIG. 4C has roughly eight areas 61, 62, 63, 64, 65, 66, 67, 68 of a pattern of the diffraction lines 13, by which diffraction lines of the adjacent areas are in each case arranged vertically to each other.

On the basis of the consistent statistical allocation of the arrangement of a large number of pigment platelets within a surface of one object provided with pigment there emerges, in a similar way as with the different areas within a pigment platelet, an uniformization of the optical color imprint (“anisotropy”) of the pigmented surface of an object. By coating large surfaces of an object with only one kind of pigment this uniformization can be exploited. In patchy to punctiform coating with only a few pigments of one kind for producing image structures with higher resolution are, however, the pigment platelets of FIG. 4A or FIG. 4C, with several refraction line areas, advantageous.

The pigments as per invention can also combine several kinds of the coloring. So, for pigments from selectively absorbent molecules and/or with multi-layer structure (interference pigments) can be taken into account for generating color, by which an additional diffractive structure is built up which will be used for invisible authentication in the UV or IR sector.

### REFERENCE SYMBOLS

1 basic layer
2 carrier layer
3 diffractive structure/boundary surface/diffraction grating
4 sealant layer
5 indentation/predetermined breaking point
6 breaking point
1a bulge-like rise
3a rise
3d recess
10 incidental electromagnetic irradiation
11 reflected electromagnetic irradiation
12 transmitted electromagnetic radiation
21 through 24 areas of the diffraction line pattern
31 through 34 areas of the diffraction line pattern
41 through 46 areas of the diffraction line pattern
13 diffraction line

We claim:

1. Pigment with at least one surface area whose smallest measurement is at least a multiple of the largest wave length (approximately 400 nm) of ultraviolet light, whereby the pigment presents a defined diffractive structure on at least one surface area, which is at least a multiple of the largest wave length (approximately 400 nm) of ultraviolet light, wherein the pigment comprises an inner diffractive structure which is surrounded by an epitaxially applied sealant material.

2. Pigment according to claim 1 characterized in that the smallest measurement of the surface area is at least a multiple of the largest wave length (approximately 800 nm) of visible light and that the pigment on the least surface area presents at least one defined diffractive structure that has a spatial periodicity with one spatial period that is at least a multiple of the largest wave length (approximately 800 nm) of visible light.

3. Pigment according to claim 1 characterized in that it has a platelet-like shape, of which at least one surface area is the entire surface area on one of the sides of the platelet.

4. Pigment according to claim 1 characterized in that it presents a periodic diffractive structure extending over the entire pigment with a defined spatial frequency and spatial alignment.

5. Pigment according to claim 1 characterized in that it presents various areas with, in each case, divergent periodic diffractive structure.

6. Pigment according to claim 5 characterized in that the different areas with a divergent periodic diffractive structure in each case differ in the spatial frequency and/or spatial alignment of the periodic structure of the prevailing area.

7. Pigment according to claim 1 characterized in that it presents a diffractive structure for ultraviolet light and a diffractive structure for visible light.

8. Pigment according to claim 1 characterized in that it presents a rotation-symmetrical diffraction gating with a cluster of concentrically circular diffraction lines.

9. Pigment according to claim 1 characterized in that it presents a star-shaped or polygonal diffraction grating with a cluster of concentrically polygonal diffraction lines.

10. Pigment according to claim 1 characterized in that it presents a periodical diffractive structure stretching itself over the entire pigment, which is an overlay of differently determined spatial frequencies and spatial alignments

11. Pigment according to claim 10 characterized in that it is a cutout from a hologram.

12. Pigment according to claim 1 characterized in that it comprises optically permeable material, whereby the defined diffractive structure is conferred by a defined spatial allocation of the pigment thickness and/or the refraction index of the pigment material.

13. Pigment according to claim 1 characterized in that it contains an optically permeable substance in the interior of which a reflective layer is arranged.

14. Pigment according to claim 1 characterized in that the defined diffractive structure is conferred by a defined spatial allocation rises and depressions on a reflective surface layer of the pigment.

15. Pigment according to claim 1 characterized in that it presents an internal diffractive structure that is surrounded by an optically permeable sealant material.

16. Pigment according to claim 3 characterized in that its dimensions at the platelet level are in the range from between 5 μm and 200 μm and especially in the range between 10 μm and 30 μm.

17. Pigment according to claim 16 characterized in that its thickness is in the range between 0.5 μm and 5 μm.

18. Pigment according to claim 1 characterized in that it is formed from at least two layers lying on top of each other.

19. Pigment according to claim 1 characterized in that it has a defined diffractive surface structure on both platelet levels.

20. Pigment according to claim 1 characterized in that the sealant comprises a hydrophobic substance.

21. Pigment according to claim 1 characterized in that the sealant comprises a hydrophobic substance.

22. Pigment according to claim 1 characterized in that the sealant on the first platelet level comprises a hydrophobic substance and on the second platelet level from a hydrophilic substance.

23. The procedure to produce pigments with at least one surface area whose smallest measurement is at least a multiple of the largest wave length (approximately 400 nm) of ultraviolet light, whereby the pigment presents a defined diffractive structure on at least one surface area, which is at least a multiple of the largest wave length (approximately 400 nm) of ultraviolet light, and wherein the pigment has an inner diffractive structure which is surrounded by an epitaxially applied sealant material, comprising the following steps:
(a) stamping a defined diffractive structure into or onto a foil-like medium;
(b) coating of the defined diffractive structure on the medium with a sealant substance by epitaxy; and
(c) pulverizing the foil-like medium produced in Steps (a) and (b) into pigment particles.

24. Procedure according to claim 23 characterized in that Step (a) is carried out by hot stamping, Thixo stamping or reaction embossing.

25. Procedure according to claim 23 characterized in that Step (a) is carried out by lithography, specifically by electron radiation or optical lithography.

26. Procedure according to claim 23 characterized in that Step (a) is also carried out by scratching the surface of the medium.

27. Procedure according to claim 23 characterized in that in Step (b), the diffractive structure is coated with a reflective layer.

28. Procedure according to claim 23 characterized in that Step (b) is carried out by vapor or fluid deposition epitaxy.

29. Procedure according to claim 23 characterized in that Step (b) is carried out by vaporizing, in particular, with metallic fumes.

30. Procedure according to claim 23 characterized in that Step (c) also entails snipping the foil-like medium.

31. Procedure according to claim 23 characterized in that the foil-like medium employed in Step (a) presents a relatively elastic base layer as the initial layer onto which a relatively brittle second layer is introduced in and/or on which the defined diffractive structure is stamped and that Step (c) also entails trimming the foil-like medium.

32. Procedure according to claim 23 characterized in that the sealant substance employed in Step (b) is a brittle, specifically lacquer-like or resin-like, material.

33. Procedure according to claim 23 characterized in that the pulverization in Step (c) is carried out by wet pulverization.

34. Pigment powder, comprising pigments with at least one surface area whose smallest measurement is at least a multiple of the largest wave length (approximately 400 nm) of ultraviolet light, whereby the pigment presents a defined diffractive structure on at least one surface area, which is at least a multiple of the largest wave length (approximately 400 nm) of ultraviolet light, and wherein the pigment has an inner diffractive structure which is surrounded by an epitaxially applied sealant material according to produced by
(a) stamping a defined diffractive structure into or onto a foil-like medium;
(b) coating of the defined diffractive structure on the medium with a sealant substance by epitaxy, and
(c) pulverizing the foil-like medium produced in Steps (a) and (b) into pigment particles.

35. Pigment powder according to claim 34 characterized in that the pigments are coated with an auxiliary agent.

36. Pigment powder according to claim 35 characterized in that the auxiliary agent is a wetting agent.

37. Print color that contains a pigment powder produced in accordance with one of the claims from 34 to 36.

38. Lacquer that contains pigment powder produced in accordance with one of the claims from 34 to 36.

39. Transparent plastic, specifically PET, PEN, PST, PA, PC, which contains a pigment powder produced in accordance with one of the claims from 34 to 36.

40. Document, which, for its authentication, presents one of the following characteristics:
a printed imprint from print color as well as ink in accordance with claim 37;
a label made from transparent synthetic material in accordance with claim 39.
